(19) United States
(12) Patent Application Publication
(10) Pub. No.: US 2011/0020527 A1
(43) Pub. Date: Jan. 27, 2011

(54) CONCENTRATE PASTE FOR DIPS/SPREADS AND PROCESS FOR THEIR PREPARATION

(76) Inventors: Eli Hugo Budman, Moshav Bat-Shlomo (IL); Marcelo Adrian Adato, Moshav Bat-Shlomo (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 12/160,576

(22) PCT Filed: Feb. 1, 2007
(86) PCT No.: PCT/IL07/00125

§ 371 Date: Oct. 29, 2008

(30) Foreign Application Priority Data
Feb. 2, 2006 (IL) 173523

(51) Int. Cl. A23L 1/20; A23L 1/36

(52) U.S. Cl. 426/634

(57) ABSTRACT

An edible paste concentrate consisting of ground chickpeas, cooked and dried, and crushed sesame seeds is provided. The paste has a shelf life of at least three months, and when mixed with water, provides a dip or a spread with the flavor and texture of freshly prepared hummus. Also provided is a process for manufacturing a spread or a dip from chickpeas or other legumes.

### FIELD OF THE INVENTION

The present invention relates to the field of food products. Particularly, the invention relates to the production of a paste which may be made into a dip, or a spread, with the addition of water.

### BACKGROUND OF THE INVENTION

Various dips and spreads, such as hummus and tehina, originate in the Middle East, though nowadays they are known to be used in kitchens around the world. Hummus, probably the most well known dip, is comprised of water, ground cooked chickpeas, ground sesame seeds, and seasonings such as salt, lemon juice, garlic and ground black pepper.

Freshly prepared hummus is very prone to spoilage by bacteria, thus its shelf life is very short. Refrigerated, hummus will last for a week at the most, and at room temperature it will spoil within hours. One type of bacteria that may grow on hummus is Salmonella, which is known to cause serious stomach upsets, and even death, mostly in infants, elderly people, and people with impaired immune systems.

Food manufacturers commonly extend the shelf life of various products, including hummus and other dips, by the addition of preservatives. The use of artificial chemical preservatives is believed to be unhealthy, and further, the preservatives usually impair the taste of the food to which they are added. In addition, even with preservatives, hummus will last for only a few weeks in refrigeration, which in itself affects its flavor.

Acidification may also be used in order to prolong the shelf life of food, including hummus, and other dips. Such acidification greatly impairs the taste of the hummus, while postponing spoilage by only a few weeks.

Hummus may also be pasteurized and canned, though ground sesame seeds are known to be very sensitive to heat, thus such a procedure damages the flavor and texture of the hummus.

Chickpeas have been cooked, ground and dried in the art, thus producing a powder from which hummus can be made. However, without tehina the flavor of the produced hummus is very poor and, in addition, the preparation process is inconvenient. Ready-made hummus cannot be dried effectively since, as already explained, sesame seeds are very sensitive to heat.

U.S. Pat. No. 6,602,531 and U.S. Pat. No. 6,787,171 disclose methods for the pre-processing of dried foods, aimed at providing dried food products with preferred reconstitution characteristics, including the prolonging of the shelf life of the product. However, the disclosed methods are appropriate for raw material, such as grains and legumes, including chickpeas, but cannot be used on ready-made hummus.

It is highly desirable to develop a procedure by which the shelf life of hummus, or other dips, may be extended, while preserving the original flavor of the dip.

It is an object of the present invention to provide a paste with long shelf life, whereby the addition of water to the paste will conform it into ready-made hummus without impairment of flavoring or texture.

It is another object of the present invention to provide a process by which such a paste can be manufactured.

It is a further object of the present invention to provide a paste for preparing dips other than hummus by replacing the chickpeas with other legumes.

Further purposes and advantages of this invention will appear as the description proceeds.

### SUMMARY OF THE INVENTION

The edible paste concentrate of the present invention comprises:
a. dry powder composed of cooked, dried, and ground chickpeas;
b. crushed sesame seed paste; and optionally
c. oil and/or seasoning.

In another aspect, the present invention relates to a process for manufacturing such an edible paste concentrate, comprising the steps of:
a. cooking the chickpeas;
b. grinding the chickpeas into a smooth puree;
c. drying the puree into a powder;
d. mixing the powder with crushed sesame seed paste; and, optionally
e. adding oil and/or seasoning.

According to a preferred embodiment of the present invention the chickpeas are soaked in water before being cooked for a required period of time. In a further embodiment of the present invention, sodium bicarbonate is added into the water in which the chickpeas are soaked.

In another embodiment of the present invention, step (c) of the process described hereinabove is performed using a spray drying method.

The paste of the present invention has a shelf life of at least three months at room temperature, and is therefore a highly desired product.

The paste of the present invention may be used in the manufacture of a spread or a dip. In one embodiment of the present invention the spread or dip are prepared by adding water to the paste of the present invention. In one preferred embodiment of the present invention approximately 0.9-1.3 g of water are added for each 1.0 g of paste. Thus the invention is also directed to a hummus spread or dip, comprising the paste of the invention and water.

In one embodiment of the present invention the chickpea powder is replaced with the powder of any other cooked, dried and ground legume, such as lentils, lupine, kidney, red or black beans.

All the above and other characteristics and advantages of the invention will be further understood through the following illustrative and non-limitative description of preferred embodiments thereof.

### DETAILED DESCRIPTION OF PREFERRED EMBODIMENTS

The paste from which hummus is produced is comprised mainly of chickpea powder and tehina, i.e. ground sesame seeds. Ingredients such as oil, salt, dry citric acid, and spices may be added to the paste. The shelf life of the paste obtained according to the invention is at least three months, and the final flavor and texture are those of freshly prepared hummus.

In order to produce the chickpea powder, the chickpeas are preferably soaked in water, typically for about 8-10 hours, so as to reduce the cooking time. In one preferred embodiment of the invention sodium bicarbonate is added to the water in order to assist in the softening of the chickpeas.

The chickpeas are then boiled in water, preferably in a pot or pan opened to the air, for approximately two hours, until they become soft. The actual length of time needed for cooking the chickpeas depends both on the type of chickpea used and on the desired texture of the final product.

The cooked chickpeas are then ground into a smooth puree, using, for example, a machine with rotating blades, such as a food processor. The puree is then dried into a powder.

According to a preferred embodiment of the invention the drying process of the puree is performed using a spray drying method. Such methods are known and consist mainly of:

1) atomization, i.e. the creation of droplets of the substance which is to be dried;
2) dehydration of the droplets in a stream of hot dry gas, usually air, thereby to produce a powder;
3) separation of the powder from the moist gas; and
4) cooling.

The dehydrated powder produced from such a method contains less than 5% water.

The puree can be dehydrated by any other suitable technique, such as fluidized bed drying, freezer drying, flash drying, etc. Dryers are well known in the art and are also widely used in the food industry, and many types of dryers exist. The skilled person will thus easily select a suitable dryer for carrying out the process of the invention.

The puree is fed into the drying chamber, for example through an atomizer or a set of nozzles, or by any other suitable means, preferably from the top. The produced powder is then transferred by suction into another compartment where it is collected in a cyclone, which uses centrifugal force to separate the dry powder from the moist air. The produced powder typically contains less than 5% water.

Once the puree has been dried into a powder, the powder is mixed with ground sesame seed paste, i.e. tehina. According to a preferred embodiment of the invention, ingredients such as oil, salt, dry citric acid, garlic and ground black pepper may be added to the final product.

If dips other than hummus are to be prepared, the above process may be applied to other kinds of food, replacing the chickpeas with other legumes such as lentils, lupine, kidney, red or black beans.

The invention will be further illustrated with reference to the following illustrative examples, which are not intended to limit the scope of the invention in any manner.

### Example 1

10 kilograms of chickpeas were soaked in water containing 215 grams of sodium bicarbonate for 12 hours. The soaked chickpeas were cooked for 2 hours. After cooking, the chickpeas were ground into a smooth puree using a food processor.

The puree was diluted with water to a level of 14-18% of dry solids, and then strained through a strainer comprising holes with a diameter of 1 mm. The diluted solution was dispersed into small droplets by an atomizer comprising holes with a diameter of 1.4 mm, and rotating at 23,500 rpm. The droplets were then dried into a powder by way of a stream of hot air at 190° C. The dry powder was separated from the moist air by centrifugal action in a cyclone, and collected at the bottom of the chamber. After the drying process the chickpea powder contained less than 5% of water.

The drying process described hereinabove was performed in a Niro-Gea spray dryer, pilot model, comprising an atomizer. The evaporation rate of this model is 15-20 kg water/hour.

40 g of dry chickpea powder were combined with 45 g of tehina paste, 15 g of vegetable oil, 1 g of salt, 0.8 g of citric acid powder, and 0.75 g of dry garlic powder, thereby creating a paste according to the invention. The paste can be stored for at least three months without deteriorating or losing its natural taste. Mixing the produced amount of paste with 110 g of water, at any time during its shelf life, results in a ready-to-eat hummus spread.

The typical nutrition values of the main components, and product (neglecting seasoning), are detailed in Table I:

TABLE I

| | Protein | Fat | Carbohydrates | Water |
|---|---|---|---|---|
| Chickpea powder | 22.4% | 5.2% | 66.5% | 5% |
| Tehina paste | 17% | 54% | 19% | 3% |
| Vegetable oil | — | 100% | — | — |
| Product (before | 16.7% | 41.3% | 34% | up to 5% |
| addition of water) | | | | |
| Product (after | 7.95% | 19.6% | 16% | ~54.5% |
| addition of water) | | | | |

### Example 2

10 kilograms of chickpeas were soaked in water containing 215 grams of sodium bicarbonate for 12 hours. The soaked chickpeas were cooked for 2 hours. After cooking, the chickpeas were ground into a smooth puree using a food processor.

The puree was diluted with water to a level of 14-18% of dry solids, and then strained through a strainer comprising holes with a diameter of 1 mm. The diluted solution was dispersed into small droplets by an atomizer comprising holes with a diameter of 1.4 mm, and rotating at 23,500 rpm. The droplets were then dried into a powder by way of a stream of hot air at 190° C. The dry powder was separated from the moist air by centrifugal action in a cyclone, and collected at the bottom of the chamber. After the drying process the dry chickpea powder contained less than 5% of water.

The drying process described hereinabove was performed in a Niro-Gea spray dryer of Example 1.

50 g of dry chickpea powder were combined with 50 g of tehina paste, 1.1 g of salt, 1.0 g of citric acid powder, and 0.9 g of dry garlic powder, thereby creating a paste according to the invention. Mixing the produced amount of paste with 140 g of water at any time during its shelf life, results in a ready-to-use hummus spread.

The typical nutrition values of the main components, and product (neglecting seasoning), are listed in Table II:

TABLE II

| | Protein | Fat | Carbohydrates | Water |
|---|---|---|---|---|
| Chickpea powder | 22.4% | 5.2% | 66.5% | 5% |
| Tehina paste | 17% | 54% | 19% | 3% |
| Product (before | 19.7% | 29.6% | 42.7% | up to 5% |
| addition of water) | | | | |
| Product (after | 8.2% | 12.3% | 17.8% | ~60.5% |
| addition of water) | | | | |

### Example 3

10 kilograms of chickpeas were soaked in water containing 215 grams of sodium bicarbonate for 12 hours. The soaked chickpeas were cooked for 2 hours. After cooking, the chickpeas were ground into a smooth puree using a food processor.

The puree was diluted with water to a level of 14-18% of dry solids, and then strained through a strainer comprising holes with a diameter of 1 mm. The diluted solution was dispersed into small droplets by an atomizer comprising holes with a diameter of 1.4 mm, and rotating at 23,500 rpm. The droplets were then dried into a powder by way of a stream of hot air at 190° C. The dry powder was separated from the moist air by centrifugal action in a cyclone, and collected at the bottom of the chamber. After the drying process the dry chickpea powder contained less than 5% of water.

The drying process described hereinabove was performed in the Niro-Gea spray dryer of Example 1.

50 g of dry chickpea powder were combined with 35 g of tehina paste, 13 g of vegetable oil, 2 g of olive oil, 1.0 g of salt, 1.0 g of citric acid powder, and 0.8 g of dry garlic powder, thereby creating a paste according to the invention. Mixing the produced amount of paste with 120 g of water, at any time during its shelf life, results in a ready-to eat hummus spread. The typical nutrition values of the main components, and product (neglecting seasoning), are detailed in Table III:

TABLE III

| | Protein | Fat | Carbohydrates | Water |
|---|---|---|---|---|
| Chickpea powder | 22.4% | 5.2% | 66.5% | 5% |
| Tehina paste | 17% | 54% | 19% | 3% |
| Vegetable oil | — | 100% | — | — |
| Product (before | 17.2% | 36.5% | 40.0% | up to 5% |
| addition of water) | | | | |
| Product (after | 7.8% | 16.6% | 18.2% | ~56.7% |
| addition of water) | | | | |

Although embodiments of the invention have been described by way of illustration, it will be understood that the invention may be carried out with many variations, modifications, and adaptations, without departing from its spirit or exceeding the scope of the claims.

1-13. (canceled)

14. A preservative-free hummus concentrate comprising:
dry powder consisting of cooked, dried, and ground chickpeas; and
crushed sesame seed paste.

15. A hummus concentrate according to claim 14, further comprising an oil.

16. A hummus concentrate according to claim 14, further comprising seasoning additives.

17. The hummus concentrate of claim 14, which has a shelf life of at least three months.

18. A process for manufacturing a preservative-free hummus with prolonged shelf-life, comprising the steps of:
a. cooking the chickpeas;
b. grinding said chickpeas into a smooth puree;
c. drying said puree into a powder having a water content of 5% or less;
d. mixing said powder with crushed sesame seed paste, thereby obtaining a hummus concentrate; and, optionally
e. adding oil and/or seasoning.

19. A process according to claim 18, further comprising adding water to said concentrate or to said concentrate with optional oil and/or seasoning.

20. A process according to claim 18, wherein from 0.7 to 1.2 g sesame seed paste are added for each one gram of said powder.

21. The process of claim 18 wherein the chickpeas are soaked in water before being cooked for about 12 hours.

22. The process of claim 21, wherein sodium bicarbonate is added to the water in which the chickpeas are soaked.

23. The process of claim 18, wherein step c. is carried out by spray-drying.

24. The process according to claim 19, wherein approximately 0.9-1.4 g of water are added for each 1.0 g of said concentrate.

25. A preservative-free hummus concentrate according to claim 14 wherein at least a part of the chickpeas powder is replaced with the powder of any other suitable cooked, dried and ground legume.
